(19) United States
(12) Patent Application Publication
(10) Pub. No.: US 2009/0029124 A1
(43) Pub. Date: Jan. 29, 2009

(54) IMAGE FORMATION METHOD, PERSONAL AUTHENTICATION MEDIUM USING THE SAME, AND DETERMINATION APPARATUS

(75) Inventor: Junichi Washizuka, Kawasaki-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/179,138

(22) Filed: Jul. 24, 2008

(30) Foreign Application Priority Data
Jul. 26, 2007 (JP) 2007-194827

(51) Int. Cl. B32B 5/16; B05D 5/00; G06K 9/78

(52) U.S. Cl. 428/207; 427/256; 356/71

(57) ABSTRACT

A personal authentication medium includes a substrate, and a pearl pigment ink image layer formed on the substrate by using heat transfer fusion inks containing pearl pigments. The distance between the centers of dots or lines forming the pearl pigment ink image layer is 0.5 to 100 times the largest one of the average grain sizes of the pearl pigments used. Each heat transfer fusion ink contains a pearl pigment having an interference light color corresponding to one of the three additive primary colors or one of the three subtractive primary colors.

### CROSS-REFERENCE TO RELATED APPLICATIONS

This application is based upon and claims the benefit of priority from prior Japanese Patent Application No. 2007-194827, filed Jul. 26, 2007, the entire contents of which are incorporated herein by reference.

### BACKGROUND OF THE INVENTION

1. Field of the Invention

The present invention relates to a personal authentication medium having a special image for preventing forgery and alteration and determining the authenticity, and a method of forming the same.

2. Description of the Related Art

Conventionally, a system for forming, by using a dye thermal diffusion recording method or thermal fusion recording method, a certificate such as an employee card or membership card having a facial image for identifying the holder of the certificate has been put into practical use. These certificates must prevent unauthorized uses. Therefore, demands have arisen for a certificate that is difficult to forge or alter and facilitates determining the authenticity.

An example of the known techniques meeting these demands is the addition of, e.g., a hologram and seal to the surface of a certificate practically used as a cash card or the like. However, it is difficult to add individual information to, e.g., the hologram and seal, so they can be forged or altered relatively easily and can readily be mass-produced.

As a technique simultaneously meeting the demands for the facility of authenticity determination and the difficulty of forgery and alteration, a method of forming a full-color personal authentication image such as a facial image by using pearl pigments having interference colors is proposed in, e.g., Japanese Patent Application No. 2001-376040.

Unfortunately, this image formation method has the problems that the visibility and color reproducibility of the interference colors are low, and the image contours blur.

### BRIEF SUMMARY OF THE INVENTION

The present invention has been made in consideration of the above situations, and has as its object to provide a personal authentication medium having an image that is superior in forgery/alteration preventing performance and facilitates authenticity determination.

An image formation method of the present invention is an information formation method including recording an image by heat transfer by using heat transfer fusion inks containing pearl pigments, wherein the distance between the centers of dots or lines forming the image is 0.5 to 100 times the largest one of the average grain sizes of the pearl pigments used. As the heat transfer fusion inks containing the pearl pigments, it is possible to use at least two types of combinations of three types of inks as subtractive primaries, i.e., heat transfer fusion ink containing a pearl pigment which develops yellow as an interference color, heat transfer fusion ink containing a pearl pigment which develops magenta as an interference color, and heat transfer fusion ink containing a pearl pigment which develops cyan as an interference color, or at least two types of combinations of three types of inks as additive primaries, i.e., heat transfer fusion ink containing a pearl pigment which develops red as an interference color, heat transfer fusion ink containing a pearl pigment which develops green as an interference color, and heat transfer fusion ink containing a pearl pigment which develops blue as an interference color.

A personal authentication medium of the present invention comprises a substrate, and a pearl pigment ink image layer formed on the substrate by using heat transfer fusion inks containing pearl pigments, wherein the distance between the centers of dots or lines forming the image is 0.5 to 100 times the largest one of the average grain sizes of the pearl pigments used. As the heat transfer fusion inks containing the pearl pigments, it is possible to use at least two types of combinations of three types of inks as subtractive primaries, i.e., heat transfer fusion ink containing a pearl pigment which develops yellow as an interference color, heat transfer fusion ink containing a pearl pigment which develops magenta as an interference color, and heat transfer fusion ink containing a pearl pigment which develops cyan as an interference color, or at least two types of combinations of three types of inks as additive primaries, i.e., heat transfer fusion ink containing a pearl pigment which develops red as an interference color, heat transfer fusion ink containing a pearl pigment which develops green as an interference color, and heat transfer fusion ink containing a pearl pigment which develops blue as an interference color.

A determination apparatus of the present invention is a determination apparatus for a personal authentication medium comprising a substrate, and a pearl pigment ink image layer formed on a substrate by using at least two types of ink selected from the group consisting of heat transfer fusion ink containing a pearl pigment which develops red as an interference color, heat transfer fusion ink containing a pearl pigment which develops green as an interference color, and heat transfer fusion ink containing a pearl pigment which develops blue as an interference color, wherein the distance between the centers of dots or lines forming the pearl pigment ink image layer is 0.5 to 100 times the largest one of the average grain sizes of the pearl pigments used, the apparatus comprising a light source configured to emit light to the pearl pigment ink image layer, a light receiving unit configured to receive light reflected by the pearl pigment ink image layer, a determination unit configured to determine the authenticity of the pearl pigments used in the personal authentication medium in accordance with the amount of the light received by the light receiving unit, and a controller configured to control the light source, light receiving unit, and determination unit.

The present invention can provide a personal authentication medium having an image that is superior in forgery/alteration preventing performance and facilitates authenticity determination.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a front view showing an example of a personal authentication medium according to the present invention;

FIG. 2 is a sectional view of FIG. 1;

FIG. 3 is a sectional view showing another example of the personal authentication medium according to the present invention; and

FIG. 4 is a schematic view showing the arrangement of an example of a determination apparatus for the personal authentication medium according to the present invention.

### DETAILED DESCRIPTION OF THE INVENTION

An image formation method according to the present invention includes forming an image by using heat transfer fusion inks containing pearl pigments having interference colors.

Also, a personal authentication medium according to the present invention includes a substrate, and a pearl pigment ink image layer formed on the substrate by using heat transfer fusion inks containing pearl pigments.

The heat transfer fusion inks containing pearl pigments used in the present invention have interference colors selected from two combinations of the three primary colors. One is a combination of yellow, cyan, and magenta as interference colors, and the other is a combination of red, blue, and green as interference colors.

The distance between the centers of dots or lines forming the pearl pigment ink image layer formed by using the heat transfer fusion inks is 0.5 to 100 times the largest one of the average grain sizes of pearl pigments used.

A personal authentication medium can be readily obtained by forming, e.g., heat transfer fusion ink ribbons by using the heat transfer fusion inks having the interference colors of one of the two combinations of the three primary colors, bringing the ink ribbons into contact with a transfer material, a heat transfer fusion ink receiving layer, or the like, performing tone recording by applying a heat transfer recording member such as a thermal head to the support side while changing the size of dots, thereby forming a transfer image such as a photographic image having full colors obtained by the interference colors. The heat transfer fusion ink receiving layer can be preformed on the substrate surface of the transfer material. Alternatively, it is possible to form an image receiving layer on the support, form an image on this image receiving layer, and transfers the image onto the transfer material.

The pearl pigment ink image layer used in the present invention can apparently be formed by colors complementary to the interference colors of the pearl pigments. When this image is inclined and viewed obliquely, there is an angle at which a natural-tone, full-color image obtained by the interference colors can be seen. In the present invention, the distance between the centers of dots or lines as units forming the pearl pigment ink image layer is 0.5 to 100 times the largest one of the average grain sizes of the pearl pigments used. This makes it possible to improve the clearness and visibility of the image obtained by the interference light, and facilitate accurately and rapidly determining authenticity.

The pearl pigment ink image layer used in the present invention can easily be formed by using the heat transfer fusion ink ribbons containing pearl pigments. Also, the authenticity of the image can be determined by only obliquely viewing the image without using any special apparatus or the like. Accordingly, the personal authentication medium of the present invention reduces the costs of formation and authenticity determination, has a high forge/alteration preventing performance, and facilitates authenticity determination.

The pearl pigments described above can have an average grain size of 2 to 150 μm. In addition, when using a pearl pigment having an average grain size of 5 to 50 μm, it is possible to relatively decrease the dot size, and improve tonality. If the average grain size of the pearl pigment is less than 5 μm, the luminance of the interference light often decreases. Therefore, the pearl pigment must have a certain grain size.

The authenticity can be determined by comparing the apparent image of the pearl pigment ink image layer with the image of the interference colors. It is also possible to form another image having a pattern corresponding to the pearl pigment ink image layer by using heat transfer fusion ink or heat transfer sublimation ink, and compare this image with the interference-color image of the pearl pigment ink image layer.

The present invention will be explained in more detail below with reference to the accompanying drawing.

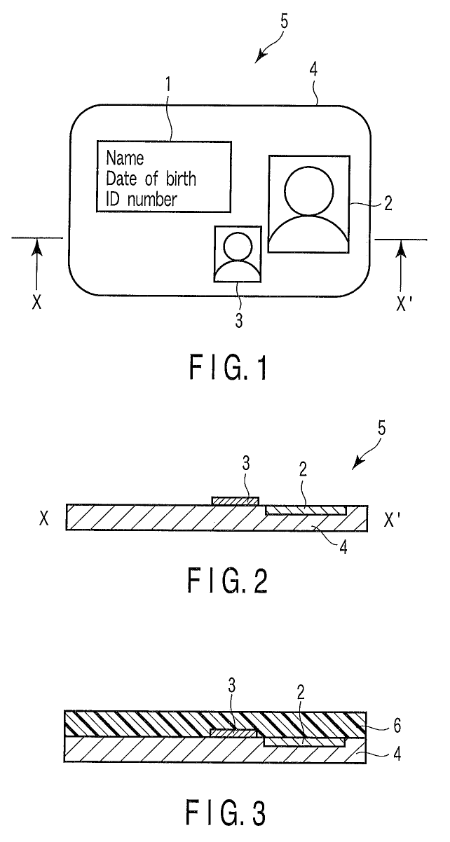

FIG. 1 is a front view of an ID card as an example of the personal authentication medium according to the present invention.

FIG. 2 is a sectional view of FIG. 1.

As shown in FIGS. 1 and 2, an ID card 5 comprises a substrate 4 formed by using paper, plastic, or the like, a heat transfer sublimation ink facial image 2 formed on one surface of the substrate 4 by using, e.g., heat transfer sublimation ink, a character information image 1 describing the status, certified qualifications, and the like, and a pearl pigment ink facial image 3 printed by using heat-sensitive heat transfer fusion ink ribbons made of inks containing pearl pigments of three colors. Note that the heat transfer sublimation ink facial image 2 can be omitted if necessary.

When the ID card 5 is inclined or obliquely viewed, there is an angle at which the interference colors alone can be clearly seen, and the pearl pigment ink facial image layer 3 can been seen in natural full colors only at this angle. The authenticity of the ID can be readily determined by comparing the interference-color image of the pearl pigment ink facial image 3 with the heat transfer sublimation ink facial image 2.

FIG. 3 is a sectional view showing another example of the personal authentication medium according to the present invention.

As shown in FIG. 3, a covering layer 6 can be formed on a substrate 4 with a pearl pigment ink facial image 3 being sandwiched between them.

Since the covering layer 6 can smooth the pearl pigment ink facial image layer 3, it is possible to suppress the irregular reflection of reflected light on the surface of the pearl pigment ink facial image layer 3, and transmit the reflected light more efficiently.

To transmit the reflected light more efficiently, the refractive index of the covering layer is preferably equal to that of the pearl pigment ink facial image layer, or the difference between the two refractive indices is preferably small.

For this reason, as the material of the covering layer, it is possible to use the same binder resin as that used in the pearl pigment ink facial image layer.

The covering layer can have a refractive index of, e.g., 1.35 to 1.76, and the pearl pigment ink image layer can have a refractive index of, e.g., 1.50 to 1.60.

The authenticity can be determined by checking the authenticity of the pearl pigments.

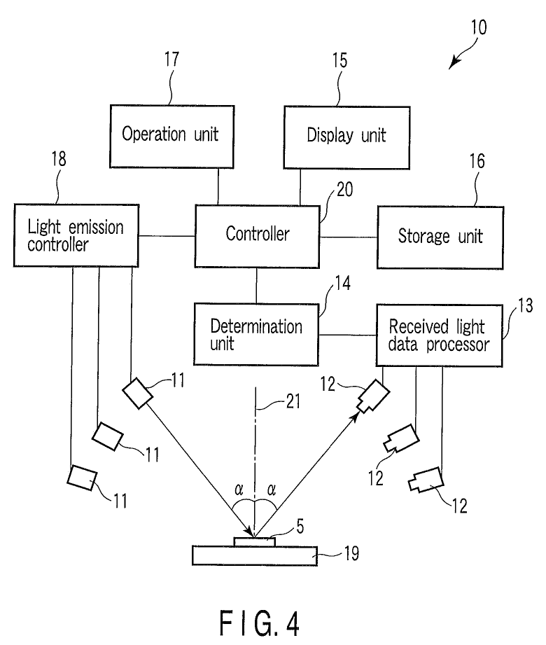

FIG. 4 is a schematic view showing the arrangement of an example of a determination apparatus for the personal authentication medium according to the present invention.

As shown in FIG. 4, a determination apparatus 10 comprises a controller 20, light emission controller 18, light source 11, reflected light receiving unit 12, received light data processor 13, and determination unit 14. The determination apparatus 10 further comprises a display unit 15, storage unit 16, and operation unit 17 connected to the determination unit 14 via the controller 20. The controller 20 mainly controls the determination apparatus 10. The light emission controller 18 receives a signal from the controller 20 and controls light emission. The light source 11 receives a signal from the light emission controller 18, and emits light such as white light to a pearl pigment ink image layer. The reflected light receiving unit 12 receives reflected light from the pearl pigment ink image layer. The received light data processor 13 calculates the light amount by processing data of the light received by the reflected light receiving unit 12. The determination unit 14 determines the authenticity of pearl pigments used in the personal authentication medium on the basis of light amount information from the received light data processor 13. The display unit 15 displays, e.g., information based on the determination result from the determination unit 14. The storage unit 16 stores information such as the determination result as needed. The operation unit 17 allows the user to operate the determination apparatus 10.

In the determination apparatus 10, the personal authentication medium according to the present invention is placed as a sample on a table 19.

This personal authentication medium comprises a substrate, and a pearl pigment ink image layer formed on the substrate by using at least two types of inks selected from heat transfer fusion ink containing a pearl pigment that develops red as an interference color, heat transfer fusion ink containing a pearl pigment that develops green as an interference color, and heat transfer fusion ink containing a pearl pigment that develops blue as an interference color, or at least two types of inks selected from heat transfer fusion ink containing a pearl pigment that develops yellow as an interference color, heat transfer fusion ink containing a pearl pigment that develops magenta as an interference color, and heat transfer fusion ink containing a pearl pigment that develops cyan as an interference color. The distance between the centers of dots or lines forming the pearl pigment ink image layer is 0.5 to 100 times the largest one of the average grain sizes of the pearl pigments used.

When the interference angle of a pearl pigment as an object of determination is an axial direction inclined α° to an axial direction perpendicular to the surface of the pearl pigment ink image layer, white light can be emitted to the pearl pigment ink image layer from the light source 11 positioned on the axis inclined α° to an axis 21 perpendicular to the surface of the pearl pigment ink image layer. Subsequently, the reflected light is received by using the light receiving unit 12 positioned on an axis inclined α°, on the side opposite to the light source 11, to the axial direction perpendicular to the surface of the pearl pigment ink image layer. Data of the light received by the light receiving unit 12 is supplied to the received light data processor 13. The received light data processor 13 converts the received light data into light amount information, and supplies the information to the determination unit 14. The determination unit 14 can determine that the pearl pigment is authentic if the level of the light amount information is equal to or larger than a predetermined threshold value, and that the pearl pigment is false if the level is smaller than the threshold value.

The interference angle can change from one pearl material used to another. For example, red, green, and blue pearl pigments respectively have interference angles of 0°, 5°, and 5°. Therefore, the light source 11 and light receiving unit 12 can be arranged to be movable in accordance with a pearl pigment to be measured. Alternatively, as shown in FIG. 4, it is also possible to arrange a plurality of light sources 11 and a plurality of light receiving units 12 in a plurality of fixed positions in accordance with the number and interference angles of pearl pigments to be measured.

The determination unit 14 supplies the determination result to the main controller 20. The main controller 20 can perform control, e.g., display the display result on the display unit 15 or store the determination result in the storage unit 16 as needed. The controller 20 is connected to the operation unit 17. Therefore, the user can designate, e.g., on/off of the determination apparatus 10 or determination of the next sample, from the operation unit 17.

The heat transfer fusion ink containing a pearl pigment of a predetermined color can be printed by using a heat-sensitive heat transfer fusion ink ribbon formed using the ink.

This heat-sensitive heat transfer fusion ink ribbon made of ink containing a pearl pigment has a substrate, back-side layer, and ink layer. The ink layer contains the pearl pigment and a binder resin.

Examples of a pearl pigment that develops yellow as an interference color usable in the present invention are Ultimica YD-100, Ultimica YE-100, and Pearl-Glaze MY-2100R manufactured by Nihon Koken Kogyo, Iriodin/Afflair 205 and Iriodin/Afflair 249 manufactured by Merck Japan, and Hi-Lite Sparkle Gold 9220J manufactured by Engelhard Corporation.

Examples of a pearl pigment that develops magenta as an interference color usable in the present invention are Ultimica RBB-100, Ultimica RBD-100, and Ultimica RBE-100 manufactured by Nihon Koken Kogyo, Iriodin/Afflair 215 and Iriodin/Afflair 259 manufactured by Merck Japan, and Hi-Lite Sparkle Orange 9320J and Hi-Lite Sparkle Red 9420J manufactured by Engelhard Corporation.

Examples of a pearl pigment that develops cyan as an interference color usable in the present invention are Ultimica BB-100, Ultimica BD-100, and Ultimica BE-100 manufactured by Nihon Koken Kogyo, Iriodin/Afflair 225 and Iriodin/Afflair 289 manufactured by Merck Japan, and Hi-Lite Sparkle Blue 9620J manufactured by Engelhard Corporation.

Examples of a pearl pigment that develops red as an interference color usable in the present invention are Ultimica RBD-100, Ultimica RBE-100, Pearl-Glaze MR-100R, Pearl-Glaze MRB-100R, and Pearl-Glaze MRB-2100R manufactured by Nihon Koken Kogyo, Iriodin/Afflair 215 and Iriodin/Afflair 259 manufactured by Merck Japan, and Hi-Lite Sparkle Orange 9320J and Hi-Lite Sparkle Red 9420J manufactured by Engelhard Corporation.

Examples of a pearl pigment that develops green as an interference color usable in the present invention are Ultimica GB-100, Ultimica GD-100, and Ultimica GE-100 manufactured by Nihon Koken Kogyo, and Iriodin/Afflair 231, Iriodin/Afflair 235, and Iriodin/Afflair 299 manufactured by Merck Japan.

Examples of a pearl pigment that develops blue as an interference color usable in the present invention are Ultimica BD-100, Ultimica BE-100, Pearl-Glaze MB-100R, and Pearl-Glaze MB-2100R manufactured by Nihon Koken Kogyo, Iriodin/Afflair 225 and Iriodin/Afflair 289 manufactured by Merck Japan, and Hi-Lite Sparkle Blue 9620J manufactured by Engelhard Corporation.

The pearl pigments described above each contain relatively large grains having an average grain size of 2 to 150 μm. To obtain better tonality, however, it is favorable to decrease the dot size by using a pearl pigment containing relatively small grains having an average grain size of 5 to 50 μm.

Examples of a pearl pigment that develops yellow as an interference color and contains relatively small grains are Ultimica YB-100 and Pearl-Glaze MY-100RF manufactured by Nihon Koken Kogyo, Iriodin/Afflair 201 manufactured by Merck Japan, and Hi-Lite Sparkle Gold 9230Z, Micro Gold 9260M, Dynacolor BY-B 9239ZB15AA, and Dynacolor GY 9239ZG7A manufactured by Engelhard Corporation.

Examples of a pearl pigment that develops magenta as an interference color and contains relatively small grains are Ultimica RBB-100, Ultimica RBD-100, and Ultimica RBE-100 manufactured by Nihon Koken Kogyo, Iriodin/Afflair 215 and Iriodin/Afflair 259 manufactured by Merck Japan, and Hi-Lite Sparkle Orange 9320J and Hi-Lite Sparkle Red 9420J manufactured by Engelhard Corporation.

Examples of a pearl pigment that develops cyan as an interference color and contains relatively small grains are Ultimica BB-100, Ultimica BD-100, and Ultimica BE-100 manufactured by Nihon Koken Kogyo, Iriodin/Afflair 225 and Iriodin/Afflair 289 manufactured by Merck Japan, and Hi-Lite Sparkle Blue 9620J manufactured by Engelhard Corporation.

Examples of a pearl pigment that develops red as an interference color and contains relatively small grains are Ultimica RB-100, Ultimica RBB-100, and Pearl-Glaze MRB-100RF manufactured by Nihon Koken Kogyo, Iriodin/Afflair 211 manufactured by Merck Japan, and Hi-Lite Sparkle Orange 9330Z, Hi-Lite Sparkle Red 9430Z, Micro Orange 9360M, Micro Red 9460M, and Hi-Lite Sparkle Red 9420J manufactured by Engelhard Corporation.

Examples of a pearl pigment that develops green as an interference color and contains relatively small grains are Ultimica GB-100, Ultimica GD-100, and Ultimica GE-100 manufactured by Nihon Koken Kogyo, and Iriodin/Afflair 231, Iriodin/Afflair 235, and Iriodin/Afflair 299 manufactured by Merck Japan.

Examples of a pearl pigment that develops blue as an interference color and contains relatively small grains are Ultimica BB-100 and Pearl-Glaze MB-100RF manufactured by Nihon Koken Kogyo, Iriodin/Afflair 221 manufactured by Merck Japan, and Hi-Lite Sparkle Blue 9630Z, Micro Blue 9660M, Dynacolor GB 9639ZG7A, and Dynacolor RB 9639ZV19A manufactured by Engelhard Corporation.

Examples of the binder resins used in the pearl pigment-containing heat transfer fusion ink and covering layer are a vinyl acetate resin, an ethylene-vinyl acetate copolymer resin, an acrylic resin, a polyester resin, and mixtures of these resins. As the binder resins used in the pearl pigment-containing heat transfer fusion ink and covering layer, it is possible to selectively use binder resins having equal refractive indices or binder resins having a minimum refractive index difference. As the binder resins having equal refractive indices, it is possible to use resins having similar repetitive units, or binder resins having similar molecular weights.

Examples of the vinyl acetate resin are Saknohol SN-04, Saknohol SN-04S, Saknohol SN-04D, Saknohol SN-09A, Saknohol SN-09T, Saknohol SN-10, Saknohol SN-10N, Saknohol SN-17A, ASR CH-09, and ASR CL-13 manufactured by Denki Kagaku Kogyo, Mowinyl DC manufactured by Clariant Polymer, Cevian A530, Cevian A700, Cevian A707, Cevian A710, Cevian A712, and Cevian A800 manufactured by Daicel Kasei.

Examples of the ethylene-vinyl acetate copolymer resin are Evaflex 45X, Evaflex 40, Evaflex 150, Evaflex 210, Evaflex 220, Evaflex 250, Evaflex 260, Evaflex 310, Evaflex 360, Evaflex 410, Evaflex 420, Evaflex 450, Evaflex 460, Evaflex 550, and Evaflex 560 manufactured by Du Pont-Mitsui Polychemicals, Mowinyl 081F manufactured by Clariant Polymer, Evatate D3022, Evatate D3012, Evatate D4032, and Evatate CV8030 manufactured by Sumitomo Chemical, Hirodyne 1800-5, Hirodyne 1800-6, Hirodyne 1800-8, Hirodyne 3706, and Hirodyne 4309 manufactured by Hirodyne Kogyo, and Bond CZ250 and Bond CV3105 manufactured by Konishi.

Examples of the acrylic resin are Cevian A45000, Cevian A45610, Cevian A46777, and Cevian A4635 manufactured by Daicel Kasei, and Dianal BR-53, Dianal BR-64, Dianal BR-79, Dianal BR-80, Dianal BR-83, Dianal BR-85, Dianal BR-87, Dianal BR-90, Dianal BR-93, Dianal BR-101, Dianal BR-102, Dianal BR-105, Dianal BR-106, Dianal BR-107, Dianal BR-112, Dianal BR-115, Dianal BR-116, Dianal BR-117, and Dianal BR-118 manufactured by Mitsubishi Rayon.

Examples of the polyester resin are Vylon 103, Vylon 200, Vylon 220, Vylon 240, Vylon 245, Vylon 270, Vylon 280, Vylon 296, Vylon 300, Vylon 500, Vylon 530, Vylon 550, Vylon 560, Vylon 600, Vylon 630, Vylon 650, Vylonal MD1100, Vylonal MD1200, Vylonal MD1245, Vylonal MD1400, and Vylonal GX-W27 manufactured by Toyobo, and Elitel UE-3200, Elitel UE-3300, Elitel UE-3320, Elitel UE-3350, Elitel UE-3370, and Elitel UE-3380 manufactured by Unitika.

Wax can be added to the ink layer. Polyethylene wax, carnauba wax, or the like can be preferably used as this wax. Examples are Hi-Mic-2065, Hi-Mic-1045, Hi-Mic-2045, Palvax-1230, Palvax-1330, Palvax-1335, Palvax-1430, Bontex-0011, Bontex-0100, and Bontex-2266 manufactured by Nippon Seiro.

The thickness of the ink layer of the ink ribbon formed by using these pearl pigments and binder resins is desirably 0.3 to 3 μm. If the thickness is less than 0.3 μm, a sufficient image density is difficult to obtain. This decreases the contrast of the image. If the thickness is too large, small dots are difficult to print. This affects tone characteristics.

### EXAMPLES

The present invention will be explained in detail below by way of its examples and comparative examples.

A 6-μm thick transparent polyester film (Lumirror F531 manufactured by Toray) was prepared as a support. One surface of this support was coated with an ink layer coating solution having the following composition by using a gravure coater such that the film thickness after drying was 1 μm. The resultant material was dried by heating at 120° C. for 2 min., thereby obtaining a heat-sensitive heat transfer fusion ink ribbon of a predetermined color made of ink containing a pearl pigment.

| | |
|---|---|
| Methylethyl ketone | 40 parts by weight |
| Toluene | 40 parts by weight |
| Vylon 220 manufactured by | 14 parts by weight |
| Toyobo | |
| Pearl pigments described in | 6 parts by weight |
| Tables 1 to 4 | |

The heat-sensitive heat transfer fusion ink ribbons made of inks containing the pearl pigments obtained as described above were used to perform recording on a commercially available card by using a 600-dpi thermal head and adjusting the inter-dot distances of the ink images of the individual colors took numerical values shown in Tables 1 to 4 such that interference colors formed a full-color image, thereby obtaining a pearl pigment ink image layer.

The visibility of the interference color image of the obtained pearl pigment ink image layer was visually checked.

When the visibility and color reproducibility of the interference colors were high and the image contours were clear, the image was evaluated as ο. When one of the interference color visibility, interference color reproducibility, and image contour clearness was high, the image was evaluated as Δ. When none of the interference color visibility, interference color reproducibility, and image contour clearness was high, the image was evaluated as ×.

TABLE 1

| | | | Average | Maximum | Inter-dot | Inter-dot | Visibility of |
|---|---|---|---|---|---|---|---|
| | Product | Interference | grain size | average grain | distance | distance/average | interference- |
| | name | color | (μm) | size (μm) | (μm) | grain size | color image |
| Example 1 | ULTIMICA | Red | 17.5 | 17.5 | 8.75 | 0.5 | ◯ |
| | RB-100 | | | | | | |
| | ULTIMICA | Green | 17.5 | | | | |
| | GB-100 | | | | | | |
| | ULTIMICA | Blue | 17.5 | | | | |
| | BB-100 | | | | | | |
| Example 2 | ULTIMICA | Red | 17.5 | 17.5 | 17.5 | 1 | ◯ |
| | RB-100 | | | | | | |
| | ULTIMICA | Green | 17.5 | | | | |
| | GB-100 | | | | | | |
| | ULTIMICA | Blue | 17.5 | | | | |
| | BB-100 | | | | | | |
| Example 3 | ULTIMICA | Red | 17.5 | 17.5 | 875 | 50 | ◯ |
| | RB-100 | | | | | | |
| | ULTIMICA | Green | 17.5 | | | | |
| | GB-100 | | | | | | |
| | ULTIMICA | Blue | 17.5 | | | | |
| | BB-100 | | | | | | |
| Example 4 | ULTIMICA | Red | 17.5 | 17.5 | 1750 | 100 | ◯ |
| | RB-100 | | | | | | |
| | ULTIMICA | Green | 17.5 | | | | |
| | GB-100 | | | | | | |
| | ULTIMICA | Blue | 17.5 | | | | |
| | BB-100 | | | | | | |
| Comparative | ULTIMICA | Red | 17.5 | 17.5 | 5.25 | 0.3 | Δ |
| Example 1 | RB-100 | | | | | | |
| | ULTIMICA | Green | 17.5 | | | | |
| | GB-100 | | | | | | |
| | ULTIMICA | Blue | 17.5 | | | | |
| | BB-100 | | | | | | |
| Comparative | ULTIMICA | Red | 17.5 | 17.5 | 1767.5 | 101 | Δ |
| Example 2 | RB-100 | | | | | | |
| | ULTIMICA | Green | 17.5 | | | | |
| | GB-100 | | | | | | |
| | ULTIMICA | Blue | 17.5 | | | | |
| | BB-100 | | | | | | |
| Comparative | ULTIMICA | Red | 17.5 | 17.5 | 0 | 0 | X |
| Example 3 | RB-100 | | | | | | |
| | ULTIMICA | Green | 17.5 | | | | |
| | GB-100 | | | | | | |
| | ULTIMICA | Blue | 17.5 | | | | |
| | BB-100 | | | | | | |
| Comparative | ULTIMICA | Red | 17.5 | 17.5 | 2625 | 150 | X |
| Example 4 | RB-100 | | | | | | |
| | ULTIMICA | Green | 17.5 | | | | |
| | GB-100 | | | | | | |
| | ULTIMICA | Blue | 17.5 | | | | |
| | BB-100 | | | | | | |

TABLE 2

| | | | Average | Maximum | Inter-dot | Inter-dot | Visibility of |
|---|---|---|---|---|---|---|---|
| | Product | Interference | grain size | average grain | distance | distance/average | interference- |
| | name | color | (μm) | size (μm) | (μm) | grain size | color image |
| Example 5 | ULTIMICA | Red | 35 | 35 | 17.5 | 0.5 | ◯ |
| | RD-100 | | | | | | |
| | ULTIMICA | Green | 35 | | | | |
| | GD-100 | | | | | | |
| | ULTIMICA | Blue | 35 | | | | |
| | BD-100 | | | | | | |
| Example 6 | ULTIMICA | Red | 35 | 35 | 35 | 1 | ◯ |
| | RD-100 | | | | | | |
| | ULTIMICA | Green | 35 | | | | |
| | GD-100 | | | | | | |
| | ULTIMICA | Blue | 35 | | | | |
| | BD-100 | | | | | | |
| Example 7 | ULTIMICA | Red | 35 | 35 | 1750 | 50 | ◯ |
| | RD-100 | | | | | | |
| | ULTIMICA | Green | 35 | | | | |
| | GD-100 | | | | | | |
| | ULTIMICA | Blue | 35 | | | | |
| | BD-100 | | | | | | |
| Example 8 | ULTIMICA | Red | 35 | 35 | 3500 | 100 | ◯ |
| | RD-100 | | | | | | |
| | ULTIMICA | Green | 35 | | | | |
| | GD-100 | | | | | | |
| | ULTIMICA | Blue | 35 | | | | |
| | BD-100 | | | | | | |
| Comparative | ULTIMICA | Red | 35 | 35 | 10.5 | 0.3 | Δ |
| Example 5 | RD-100 | | | | | | |
| | ULTIMICA | Green | 35 | | | | |
| | GD-100 | | | | | | |
| | ULTIMICA | Blue | 35 | | | | |
| | BD-100 | | | | | | |
| Comparative | ULTIMICA | Red | 35 | 35 | 3535 | 101 | Δ |
| Example 6 | RD-100 | | | | | | |
| | ULTIMICA | Green | 35 | | | | |
| | GD-100 | | | | | | |
| | ULTIMICA | Blue | 35 | | | | |
| | BD-100 | | | | | | |
| Comparative | ULTIMICA | Red | 35 | 35 | 0 | 0 | X |
| Example 7 | RD-100 | | | | | | |
| | ULTIMICA | Green | 35 | | | | |
| | GD-100 | | | | | | |
| | ULTIMICA | Blue | 35 | | | | |
| | BD-100 | | | | | | |
| Comparative | ULTIMICA | Red | 35 | 35 | 5250 | 150 | X |
| Example 8 | RD-100 | | | | | | |
| | ULTIMICA | Green | 35 | | | | |
| | GD-100 | | | | | | |
| | ULTIMICA | Blue | 35 | | | | |
| | BD-100 | | | | | | |

TABLE 3

| | | | Average | Maximum | Inter-dot | Inter-dot | Visibility of |
|---|---|---|---|---|---|---|---|
| | Product | Interference | grain size | average grain | distance | distance/average | interference- |
| | name | color | (μm) | size (μm) | (μm) | grain size | color image |
| Example 9 | ULTIMICA | Red | 57.5 | | | | |
| | RE-100 | | | | | | |
| | ULTIMICA | Green | 57.5 | 57.5 | 28.75 | 0.5 | Δ |
| | GE-100 | | | | | | |
| | ULTIMICA | Blue | 57.5 | | | | |
| | BE-100 | | | | | | |
| Example 10 | ULTIMICA | Red | 57.5 | | | | |
| | RE-100 | | | | | | |
| | ULTIMICA | Green | 57.5 | 57.5 | 57.5 | 1 | Δ |
| | GE-100 | | | | | | |
| | ULTIMICA | Blue | 57.5 | | | | |
| | BE-100 | | | | | | |
| Example 11 | ULTIMICA | Red | 57.5 | | | | |
| | RE-100 | | | | | | |
| | ULTIMICA | Green | 57.5 | 57.5 | 2875 | 50 | Δ |
| | GE-100 | | | | | | |
| | ULTIMICA | Blue | 57.5 | | | | |
| | BE-100 | | | | | | |
| Example 12 | ULTIMICA | Red | 57.5 | | | | |
| | RE-100 | | | | | | |
| | ULTIMICA | Green | 57.5 | 57.5 | 5750 | 100 | Δ |
| | GE-100 | | | | | | |
| | ULTIMICA | Blue | 57.5 | | | | |
| | BE-100 | | | | | | |
| Comparative | ULTIMICA | Red | 57.5 | | | | |
| Example 9 | RE-100 | | | | | | |
| | ULTIMICA | Green | 57.5 | 57.5 | 17.25 | 0.3 | X |
| | GE-100 | | | | | | |
| | ULTIMICA | Blue | 57.5 | | | | |
| | BE-100 | | | | | | |
| Comparative | ULTIMICA | Red | 57.5 | | | | |
| Example 10 | RE-100 | | | | | | |
| | ULTIMICA | Green | 57.5 | 57.5 | 5807.5 | 101 | X |
| | GE-100 | | | | | | |
| | ULTIMICA | Blue | 57.5 | | | | |
| | BE-100 | | | | | | |
| Comparative | ULTIMICA | Red | 57.5 | | | | |
| Example 11 | RE-100 | | | | | | |
| | ULTIMICA | Green | 57.5 | 57.5 | 0 | 0 | X |
| | GE-100 | | | | | | |
| | ULTIMICA | Blue | 57.5 | | | | |
| | BE-100 | | | | | | |
| Comparative | ULTIMICA | Red | 57.5 | | | | |
| Example 12 | RE-100 | | | | | | |
| | ULTIMICA | Green | 57.5 | 57.5 | 8625 | 150 | X |
| | GE-100 | | | | | | |
| | ULTIMICA | Blue | 57.5 | | | | |
| | BE-100 | | | | | | |

TABLE 4

| | | | Average | Maximum | Inter-dot | Inter-dot | Visibility of |
|---|---|---|---|---|---|---|---|
| | Product | Interference | grain size | average grain | distance | distance/average | interference- |
| | name | color | (μm) | size (μm) | (μm) | grain size | color image |
| Example 13 | ULTIMICA | Yellow | 17.5 | 17.5 | 8.75 | 0.5 | ◯ |
| | YB-100 | | | | | | |
| | ULTIMICA | Magenta | 17.5 | | | | |
| | RBB-100 | | | | | | |
| | ULTIMICA | Cyan | 17.5 | | | | |
| | BB-100 | | | | | | |
| Example 14 | ULTIMICA | Yellow | 17.5 | 17.5 | 17.5 | 1 | ◯ |
| | YB-100 | | | | | | |
| | ULTIMICA | Magenta | 17.5 | | | | |
| | RBB-100 | | | | | | |
| | ULTIMICA | Cyan | 17.5 | | | | |
| | BB-100 | | | | | | |
| Example 15 | ULTIMICA | Yellow | 17.5 | 17.5 | 875 | 50 | ◯ |
| | YB-100 | | | | | | |
| | ULTIMICA | Magenta | 17.5 | | | | |
| | RBB-100 | | | | | | |
| | ULTIMICA | Cyan | 17.5 | | | | |
| | BB-100 | | | | | | |
| Example 16 | ULTIMICA | Yellow | 17.5 | 17.5 | 1750 | 100 | ◯ |
| | YB-100 | | | | | | |
| | ULTIMICA | Magenta | 17.5 | | | | |
| | RBB-100 | | | | | | |
| | ULTIMICA | Cyan | 17.5 | | | | |
| | BB-100 | | | | | | |
| Comparative | ULTIMICA | Yellow | 17.5 | 17.5 | 5.25 | 0.3 | Δ |
| Example 13 | YB-100 | | | | | | |
| | ULTIMICA | Magenta | 17.5 | | | | |
| | RBB-100 | | | | | | |
| | ULTIMICA | Cyan | 17.5 | | | | |
| | BB-100 | | | | | | |
| Comparative | ULTIMICA | Yellow | 17.5 | 17.5 | 1767.5 | 101 | Δ |
| Example 14 | YB-100 | | | | | | |
| | ULTIMICA | Magenta | 17.5 | | | | |
| | RBB-100 | | | | | | |
| | ULTIMICA | Cyan | 17.5 | | | | |
| | BB-100 | | | | | | |
| Comparative | ULTIMICA | Yellow | 17.5 | 17.5 | 0 | 0 | X |
| Example 15 | YB-100 | | | | | | |
| | ULTIMICA | Magenta | 17.5 | | | | |
| | RBB-100 | | | | | | |
| | ULTIMICA | Cyan | 17.5 | | | | |
| | BB-100 | | | | | | |
| Comparative | ULTIMICA | Yellow | 17.5 | 17.5 | 2625 | 150 | X |
| Example 16 | YB-100 | | | | | | |
| | ULTIMICA | Magenta | 17.5 | | | | |
| | RBB-100 | | | | | | |
| | ULTIMICA | Cyan | 17.5 | | | | |
| | BB-100 | | | | | | |

As shown in Tables 1 to 4, when the inter-dot distance/average grain size ratio was 0.5 to 100, the visibility of the interference light image was very high as indicated by, e.g., Examples 1 to 16. However, if this ratio slightly deviated from the above range, the visibility of the interference light image slightly worsened as indicated by, e.g., Comparative Examples 1, 2, 5, 6, 9, 10, 13, and 14. If the ratio largely deviated from the above range or the inter-dot distance was 0 because dots overlapped each other, the visibility of the interference light image worsened as indicated by Comparative Examples 3, 4, 7, 8, 11, 12, 15, and 16.

Also, as indicated by Examples 9 to 12, the interference color visibility more or less decreased if the volume average grain size of the pearl pigment was larger than 50 μm.

As described above, the present invention can provide a personal authentication medium having an image that is superior in forgery/alteration preventing performance, and facilitates authenticity determination because the visibility of an interference light image is high.

In addition, the surface of a 25-μm thick polyethyleneterephthalate film (Lumirror manufactured by Toray) was coated with a covering layer coating solution 1 by using a gravure coater such that the thickness of the coating film after drying was 1 to 5 μm, and the film was dried. After that, the film was coated with a covering layer coating solution 2 such that the thickness of the coating film after drying was 10 to 20 μm, and the film was dried. In this way, a covering layer heat transfer sheet was formed.

Composition of covering layer coating solution 1

| | |
|---|---|
| Acrylic resin (Dianal BR-83 | 20 parts by weight |
| manufactured by Mitsubishi | |
| Rayon) | |
| Methylethylketone | 40 parts by weight |
| Toluene | 40 parts by weight |

Composition of covering layer coating solution 2

| | |
|---|---|
| Polyester resin (Vylon 220 | 20 parts by weight |
| manufactured by Toyobo) | |
| Methylethylketone | 40 parts by weight |
| Toluene | 40 parts by weight |

The obtained covering layer heat transfer sheet was used to form a covering layer on a pearl pigment ink image layer by heat transfer.

The visibility of the interference color image of the pearl pigment ink image layer on which the covering layer was formed and that of the interference color image of the pearl pigment ink image layer on which no covering layer was formed were visually checked. Consequently, no big difference was found between Comparative Examples 1 to 16, but the visibility improved in Examples 1 to 16.

Also, the refractive index of the pearl pigment ink image layer was 1.55 to 1.56, and that of the covering layer was 1.48 to 1.50.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image formation method comprising forming a pearl pigment ink image layer on a substrate by using two types of inks selected from one of the group consisting of heat transfer fusion ink containing a pearl pigment which has a yellow interference color, heat transfer fusion ink containing a pearl pigment which has a magenta interference color, and heat transfer fusion ink containing a pearl pigment which has a cyan interference color, and the group consisting of heat transfer fusion ink containing a pearl pigment which has a red interference color, heat transfer fusion ink containing a pearl pigment which has a green interference color, and heat transfer fusion ink containing a pearl pigment which has a blue interference color,
wherein one of a distance between centers of dots or lines forming the pearl pigment ink image layer and a distance between centers of lines forming the pearl pigment ink image layer is 0.5 to 100 times a largest one of average grain sizes of the pearl pigments used.

2. A method according to claim 1, wherein each of the pearl pigments has a grain size of 2 to 150 μm.

3. A method according to claim 1, which further comprises forming, after the image is formed, a covering layer on the substrate with the pearl pigment ink image layer being sandwiched therebetween, and
in which each heat transfer fusion ink containing the pearl pigment and the covering layer contain similar binder resins.

4. A method according to claim 3, wherein a refractive index of the covering layer is not more than 10% of that of the pearl pigment ink image layer.

5. A personal authentication medium comprising:
a substrate; and
a pearl pigment ink image layer formed on the substrate by using at least two types of inks selected from one of the group consisting of heat transfer fusion ink containing a pearl pigment which has a yellow interference color, heat transfer fusion ink containing a pearl pigment which has a magenta interference color, and heat transfer fusion ink containing a pearl pigment which has a cyan interference color, and the group consisting of heat transfer fusion ink containing a pearl pigment which has a red interference color, heat transfer fusion ink containing a pearl pigment which has a green interference color, and heat transfer fusion ink containing a pearl pigment which has a blue interference color,
wherein one of a distance between centers of dots or lines forming the pearl pigment ink image layer and a distance between centers of lines forming the pearl pigment ink image layer is 0.5 to 100 times a largest one of average grain sizes of the pearl pigments used.

6. A medium according to claim 5, wherein each of the pearl pigments has a grain size of 2 to 150 μm.

7. A medium according to claim 5, which further comprises a covering layer formed on the substrate with the pearl pigment ink image layer being sandwiched therebetween, and
in which each heat transfer fusion ink containing the pearl pigment and the covering layer contain similar binder resins.

8. A medium according to claim 7, wherein a refractive index of the covering layer is not more than 10% of that of the pearl pigment ink image layer.

9. A medium according to claim 5, further comprising another image formed by a pattern corresponding to the pearl pigment ink image layer by using one of heat transfer fusion ink and heat transfer sublimation ink.

10. A determination apparatus for a personal authentication medium comprising a substrate, and a pearl pigment ink image layer formed on the substrate by using at least two types of inks selected from one of the group consisting of heat transfer fusion ink containing a pearl pigment which has a red interference color, heat transfer fusion ink containing a pearl pigment which has a green interference color, and heat transfer fusion ink containing a pearl pigment which has blue as an interference color and the group consisting of heat transfer fusion ink containing a pearl pigment which has a yellow interference color, heat transfer fusion ink containing a pearl pigment which has a magenta interference color, and heat transfer fusion ink containing a pearl pigment which has a cyan interference color, wherein one of a distance between centers of dots or lines forming the pearl pigment ink image layer and a distance between centers of lines forming the pearl pigment ink image layer is 0.5 to 100 times a largest one of average grain sizes of the pearl pigments used, the apparatus comprising:
a light source configured to emit light to the pearl pigment ink image layer;
a light receiving unit configured to receive light reflected by the pearl pigment ink image layer;
a determination unit configured to determine authenticity of the pearl pigments used in the personal authentication medium in accordance with an amount of the light received by the light receiving unit; and
a controller configured to control the light source, the light receiving unit, and the determination unit.

11. An apparatus according to claim 10, wherein each of the pearl pigments has a grain size of 2 to 150 μm.

12. An apparatus according to claim 10, which further comprises a covering layer formed on the substrate with the pearl pigment ink image layer being sandwiched therebetween, and
in which each heat transfer fusion ink containing the pearl pigment and the covering layer contain similar binder resins.

13. An apparatus according to claim 12, wherein a refractive index of the covering layer is not more than 10% of that of the pearl pigment ink image layer.

14. An apparatus according to claim 10, further comprising another image formed by a pattern corresponding to the pearl pigment ink image layer by using one of heat transfer fusion ink and heat transfer sublimation ink.
